(19) United States
(12) Patent Application Publication
(10) Pub. No.: US 2009/0107419 A1
(43) Pub. Date: Apr. 30, 2009

(54) Animal medical collar

(76) Inventor: Linda M. Davis, Hallsville, TX (US)

Correspondence Address: LYNN E BARBER, P O BOX 16528, FORT WORTH, TX, 76162, US

(21) Appl. No.: 11/980,295

(22) Filed: Oct. 30, 2007

(51) Int. Cl. A01K 15/04

(52) U.S. Cl. 119/815

(57) ABSTRACT

An animal medical collar including a resilient annular disk, with an annular stiffener inserted within and toward the outside of the annular disk, a soft covering over the resilient annular disk; and a tightener for the soft covering within the disk central opening.

### BACKGROUND OF THE INVENTION

1. Field of the Invention

This invention relates to animal medical collars such as pet collars used to keep animals from inflicting injury on themselves.

2. Description of the Related Art

Typically veterinarians use stiff Elizabethan style animal collars to keep animals that have been injured or are prone to excessive biting or licking of themselves from irritating the afflicted area. These collars are often bulky and uncomfortable and may be frightening and confusing to the animals, causing additional problems for the animal including keeping them from their daily activities.

A number of alternative collars have been developed, many of which are also uncomfortable and stiff, and often are also unattractive, often being repellant to the pet owners and observers. Some of the prior collars are somewhat softer and less stiff than the traditional stiff Elizabethan style collars, and include a variety of foam or other soft materials in their construction. Some of these collars have hardware or other added components to attach them to or hold them on the animal's neck. Examples of such collars are found in the following patents and the patents discussed therein.

The collar of Miller (U.S. Pat. No. 4,476,814) utilizes a split doughnut-shaped foam piece the ends of which are held together by a drawstring releasably locked together with a spring clamp or the like.

The restraint collar of Lippincott (U.S. Pat. No. 5,133,295) comprises two side-by-side floppy rings of soft padding such as laminated medical padding, which are sown together along their inner margins and have a drawstring in a passage. The rings have adjacent faces of a plastic material and opposite faces of a soft absorbent material, and are gathered to form radial pleats.

The protective pet collar of Klinkhart et al. (U.S. Pat. No. 5,778,828) has two sheets of hard but flexible material, such as low density polyethylene, fastened around the animal's neck, which may have a foam pad to make the collar more comfortable to the animal. This collar has a width adjustment made possible by a series of male and female fasteners.

The recovery collar of Schmid et al. (U.S. Pat. No. 6,044,802) has the shape of a round pillow with a central aperture. The round pillow is formed by either a single large disk or by a large and a small disk glued together or molded as one piece. Each disk is made of foam. The disks are covered with vinyl and the cover also forms a shawl extending into the aperture and having a drawstring that is tightened to fit comfortably around the animal's neck.

The adjustable pet collar of Bowen (U.S. Pat. No. 6,244,222) is simply a split cylinder of foam that is held in place on the animal's neck with a hook strap of Velcro™.

The split Elizabethan collar of Schmid (U.S. Pat. No. 6,659,046) is inflatable by means of a valve filling the collar or a circular bladder within the collar. The collar may also include a piece of foam placed in the collar or the collar may be permanently inflated. The split in the collar allows the collar to be placed around an animal's neck without slipping it over the animal's head, and then a drawstring is used to secure a shawl on the collar to the animal.

It is therefore an object of the invention to provide an animal medical collar that is both soft around the animal's neck but is also stiff enough to serve the veterinary purpose of keeping the animal from injuring itself as with the stiffer Elizabethan style collars.

It is a further object of the invention to provide a soft animal medical collar that is easily placed over an animal's head and then held in place around the animal's neck.

It is a further object of the invention to provide a soft animal medical collar that is attractive while still serving as veterinary collar.

Other objects and advantages will be more fully apparent from the following disclosure and appended claims.

### SUMMARY OF THE INVENTION

The invention herein is an animal medical collar including a resilient annular disk, with an annular stiffener inserted within and toward the outside of the annular disk, a soft covering over the resilient annular disk; and a tightener for the soft covering within the disk central opening.

Other objects and features of the inventions will be more fully apparent from the following disclosure and appended claims.

### BRIEF DESCRIPTION OF THE DRAWINGS

FIG. 1 is a perspective view of a piece of foam that may be used to form an annular disk in a first embodiment of the invention.

FIG. 2 is a perspective view of two smaller annular disks used in a second embodiment, together being the size and external shape of the annular disk of FIG. 1.

FIG. 3 is a top perspective view of the stiffener used in both embodiments of the invention.

FIG. 4 is a cross-sectional view of the smaller annular disks of FIG. 2 with the stiffener between the smaller annular disks.

FIG. 5 is a cross-sectional view of the annular disk of FIG. 1 having a slit in which the stiffener is placed.

FIG. 6 is a plan view of the stiffener placement on a smaller annular disk.

FIG. 7 is a perspective bottom view the animal collar of FIG. 6.

FIG. 8 is a perspective top view of an animal collar according the invention herein.

FIG. 9 is a partial cross-sectional view of the assembled collar of the invention.

FIG. 10 is a plan view of a piece of fabric with an edge fold.

FIG. 11 is a perspective view of an embodiment of the invention having belt loops.

### DETAILED DESCRIPTION OF THE INVENTION AND PREFERRED EMBODIMENTS THEREOF

The present invention is an animal medical collar that is generally doughnut-shaped in the form of an annular disk. This annular disk may be a single unit, or may be bifurcated in the form of two equal-sized smaller disks.

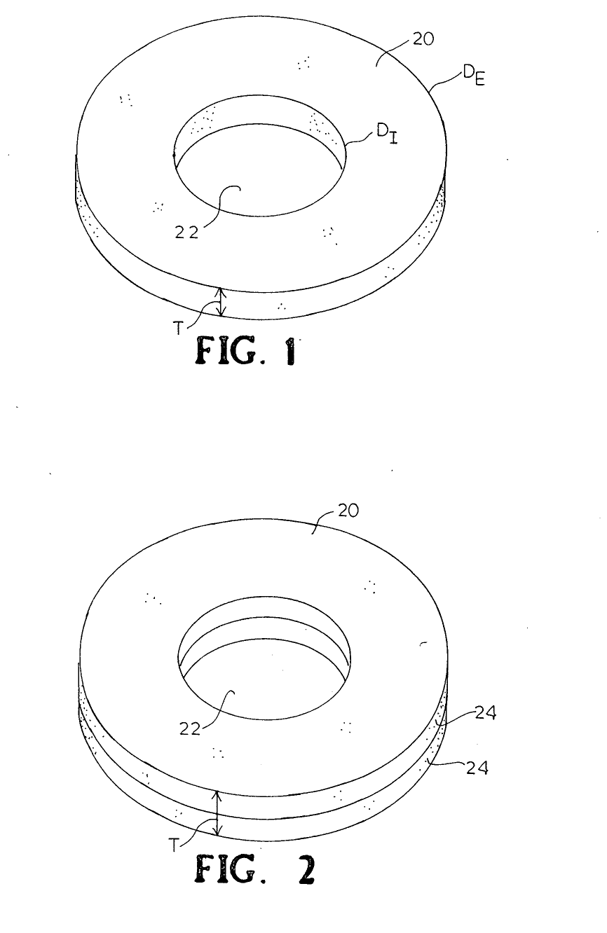

Referring now to the figures, as shown in FIG. 1, the animal medical collar 15 (Figures of the invention comprises a resilient annular disk 20 having a disk exterior circular edge D_{E} that is longer than a disk interior circular edge D_{I} around a disk central opening 22. The size of the disk central opening 22 within the disk interior circular edge D_{I} is such that it fits over the head of a selected animal. Thus, for a typical housecat, the length of the disk exterior circular edge D_{E} might be 27 inches and the length of the disk interior circular edge D_{I} might be about 9 inches, so that the collar 15 has a diameter of about 9 inches and the central opening has a diameter of about 2-2½ inches or a circumference of about 4 inches. For a smaller or larger animal, appropriate adjustments in size would be clear to one of ordinary skill in the art.

The thickness T of the resilient annular disk 20 (FIG. 1) is preferably about 2 inches, but may be smaller as desired for a smaller animal and increased in thickness as desired, particularly for larger animals. While the resilient annular disk 20 may be a single piece of foam or other soft resilient substance, preferably the annular disk comprises two shorter pieces 24 of foam, each of which is about 1 inch thick, and which have the same diameter as annular disk 22 (FIG. 2).

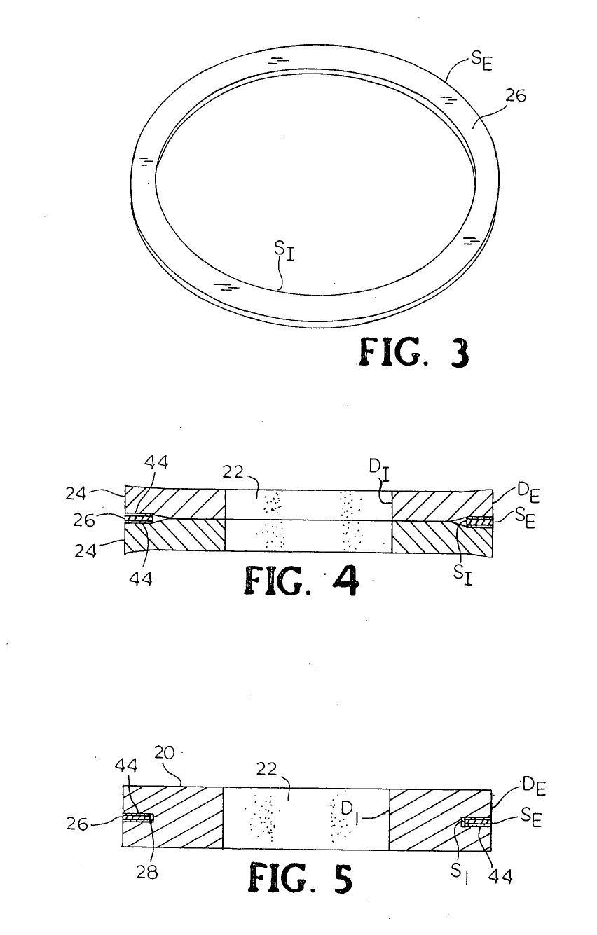

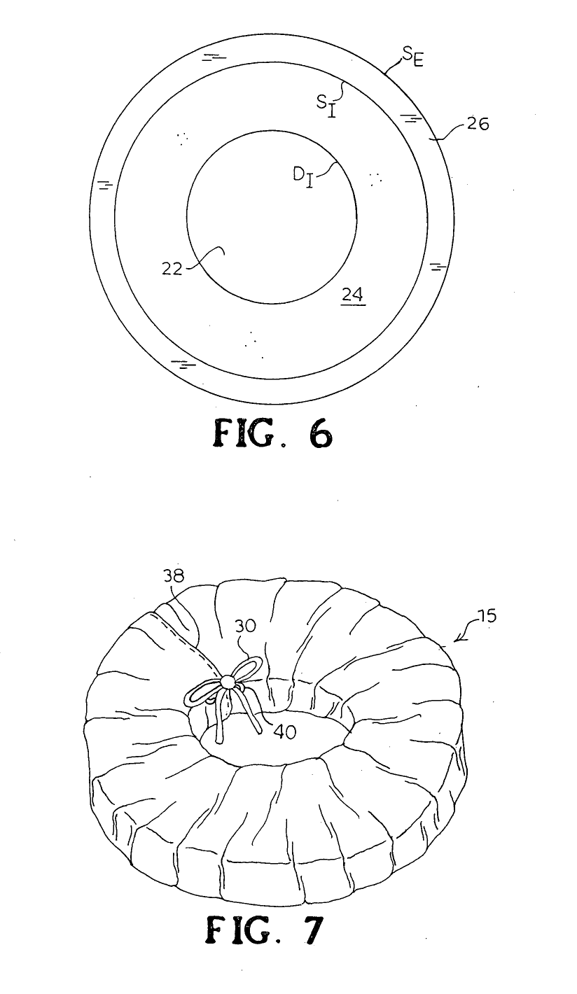

The invention also comprises an annular stiffener 26 inserted within the annular disk 20 or between annular disks 24 generally being positioned toward or at the outside of the annular disk(s) 20, 24 (FIGS. 3-6). If the annular disk 20 is a single piece of foam, a horizontal, vertically central slit 28 in the exterior of the foam may be made to insert the annular stiffener 26 (FIG. 5), while if the annular disk comprises two pieces of foam as is preferred, the annular stiffener may simply be placed between the two pieces of foam (FIG. 4). In either case, it is preferred to use an adhesive 44 (FIGS. 4 and 5) to attach the annular stiffener to the foam of the annular disk so that it is held in place and does not protrude beyond the foam at the outside of the annular disk.

The annular stiffener 24 has a stiffener exterior circular edge S_{E} less long than or equal in length to the length of the disk exterior circular edge D_{E}, and a stiffener interior circular edge S_{I} shorter than the stiffener exterior circular edge S_{E} and greater than the length of the disk interior circular edge D_{I} (FIG. 3). Preferably the stiffener 24 is a section of a planar plastic or plastic webbing about 1 inch wide and about 1/16 inch thick. While the stiffness of the stiffener keeps the outer edge of the foam disk(s) 20, 24 from being compressed inward toward the animal's neck, the stiffener is sufficiently flexible in the plane of the plastic material to allow the surrounding annular disk(s) 20, 24 of the collar to flex as the animal moves. A preferred material for the stiffener is a molded piece of a stiff but bendable plastic as is known in the art, however any flexible thin piece of stiff plastic or comparable substance may be used.

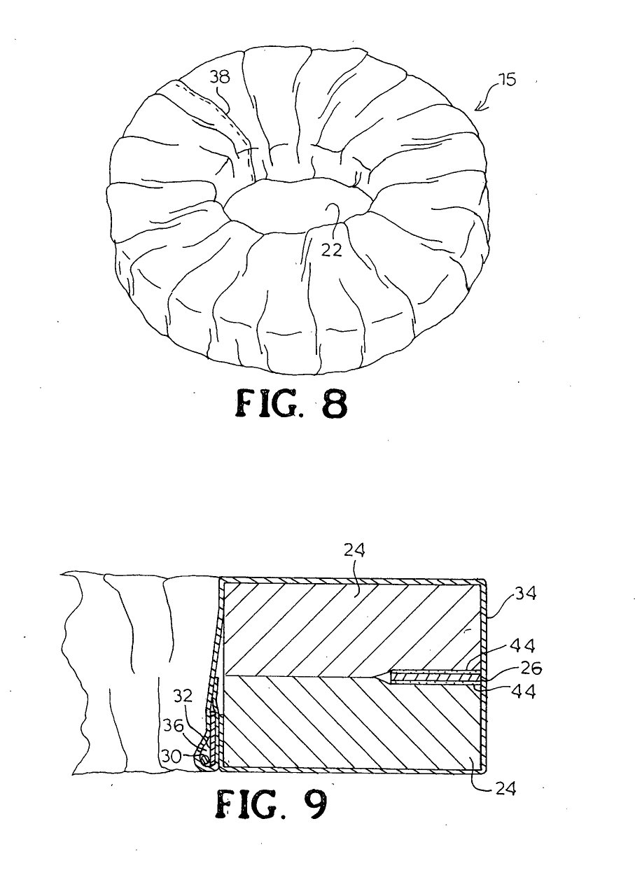

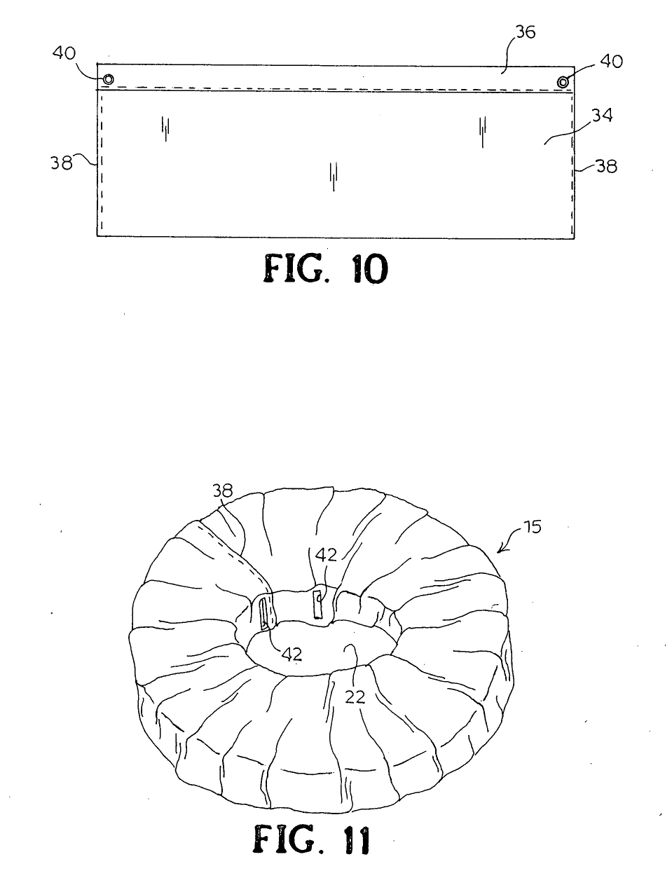

The annular disk is covered with a soft covering such as a fabric cover made as known in the art (FIGS. 7-8). A piece 34 of fabric having dimensions of about 14×36 inches that is rectangular in shape as shown in FIG. 10 is sufficient to cover the foam for the size medical collar discussed in the examples herein. During construction of the collar, one of the long edges is folded over as known in the art to form a channel 36 for placement of an elastic band 32 and a drawstring 30 (FIGS. 9-10). Preferably a length of elastic band material that is the length of the neck hole is used and thus it is preferably the same length as disk interior circular edge D_{I}.

The ends 38 of the piece 34 of fabric (shown in dashed lines in FIG. 10) are preferably sewn together to form a cylinder (not shown) as known in the art inside which the foam piece(s) are placed. The fabric cylinder is then tucked around the foam piece(s) to cover them completely as shown in FIGS. 7-8, and then the channel 36 at the folded long edge of the fabric is attached as known in the art by sewing or other means, such as by zipper or other fastener known in the art, to the opposite long edge of the fabric so that the fabric is held together around the foam piece(s).

The fabric piece 34 may be preferably further tightened within the disk central opening 22 by means of two eyelets 40 (FIG. 10) on the soft covering within the disk central opening 22 and the drawstring 30 placed through eyelets 40 as shown in FIG. 7. The drawstring 30 may simply be a shoelace, for example a 36-inch shoelace placed in the channel on the fabric piece 34 during or formation of the channel 36 as known in the art. Alternatively, the fabric within the disk central opening 22 may be held in place closely around the animal's neck by means of 3-4 or more belt loops 42 (FIG. 11) placed within the disk central opening 22. The animal's collar, for example, a snap collar (not shown) of a cat may be threaded through the belt loops and fastened by deforming the foam to allow sufficient working space to thread and fasten the collar.

While the invention has been described with reference to specific embodiments, it will be appreciated that numerous variations, modifications, and embodiments are possible, and accordingly, all such variations, modifications, and embodiments are to be regarded as being within the spirit and scope of the invention.

What is claimed is:

1. An animal medical collar comprising:
a) a resilient annular disk having a disk exterior circular edge larger than a disk interior circular edge, and a disk central opening within the disk interior circular edge sized to fit over an animal's head;
b) an annular stiffener inserted within the annular disk, the annular stiffener having a stiffener exterior circular edge shorter than or the same length as the disk exterior circular edge, and a stiffener interior circular edge shorter than the stiffener exterior circular edge and longer than the disk interior circular edge;
c) a soft covering over the resilient annular disk; and
d) a tightener for the soft covering within the disk central opening.

2. The animal medical collar of claim 1, wherein the resilient annular disk comprises two foam annular disks of equal size, and wherein the annular stiffener is between the two foam annular disks.

3. The animal medical collar of claim 2, wherein the annular stiffener is adhesively attached between the two thinner foam annular disks.

4. The animal medical collar of claim 1, wherein the resilient annular disk comprises a single foam annular disk and the annular stiffener is positioned within a slit in the foam annular disk.

5. The animal medical collar of claim 1, wherein the tightener comprises eyelets on the soft covering within the disk central opening and a drawstring placed through eyelets.

6. The animal medical collar of claim 1, further comprising an elastic band the length of the disk interior circular edge.

7. The animal medical collar of claim 1, wherein the resilient annular disk is made of soft foam.

8. The animal medical collar of claim 1, wherein the stiffener is made of a stiff but flexible plastic.

9. The animal medical collar of claim 1, wherein the tightener comprises a plurality of belt loops.

10. The animal medical collar of claim 1, wherein the soft covering is sewn together around the resilient annular disk.
